(19) United States
(12) Patent Application Publication
(10) Pub. No.: US 2005/0012880 A1
(43) Pub. Date: Jan. 20, 2005

(54) Transflective liquid crystal display panel, transflective liquid crystal display device, and manufacturing method of transflecftive liquid crystal display device

(75) Inventors: Katsumasa Yoshii, Fukushima-ken (JP); Mitsuru Kano, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/890,689

(22) Filed: Jul. 14, 2004

(30) Foreign Application Priority Data
Jul. 17, 2003 (JP) 2003-198681

(51) Int. Cl. G02F 1/1335

(52) U.S. Cl. 349/114

(57) ABSTRACT

When the thickness of a filter layer 170 in a light-reflecting portion R (the thickness of a thin portion 170a) is ‘FR’, the thickness of the filter layer 170 in a light-transmitting portion T (the thickness of a thick portion 170b) is ‘FT’, the thickness of a liquid crystal layer 150 in the light-reflecting portion R is ‘LR’, the thickness of the liquid crystal layer 150 in the light-transmitting portion T is ‘LT’, and the depth of a groove 155 is ‘D’, the depth D of the groove 155 formed in a resin layer 160 is formed to satisfy the formula D=(LT−LR)+(FT−FR). With defining (LT−LR) as ‘L’ and (FT−FR) as ‘F’, the formula becomes D=L+F. If the depth of the groove 155 satisfies the formula, it is possible to make an optical path length of external light N equal to an optical path length of illumination light B from a backlight 200 when they pass through the liquid crystal panel.

### BACKGROUND OF THE INVENTION

1. Field of the Invention

The present invention relates to a transflective liquid crystal display panel capable of displaying an image using reflected light of external light and illumination light from an illuminating device, a transflective liquid crystal display device using the same, and a manufacturing method of the transflective liquid crystal display panel.

2. Description of the Related Art

In portable electronic apparatuses, such as mobile phones and portable game machines, a transflective liquid crystal display device having low power consumption is used as a display unit since the battery drive time greatly influences the ease of use. Such a transflective liquid crystal display device is equipped with a transflective film for entirely reflecting external light (natural light) coming from the front surface of the display device, and for transmitting light emitted from a backlight through apertures formed therein. Therefore, it is possible to brightly illuminate the liquid crystal display panel using reflected light of external light or the illuminated light from an illuminating device.

In such a transflective liquid crystal display device, when an optical path length of external light is different from an optical path length of the illumination light from the illuminating device, the liquid crystal display panel does not have the same color and brightness in one mode in which external light is used as a light source for illuminating the liquid crystal display panel and in another mode in which light emitted from the backlight is used as the light source. Thus, in order to obtain the same color and brightness from the liquid crystal display device regardless of the kind of the light source for illuminating the liquid crystal display panel, conventionally, a so-called multi-gap type liquid crystal display device has been suggested (for example, see Japanese Patent Application Publication No. 2002-62525)

However, in order to make the optical path length of external light equal to the optical path length of illumination light, the above-mentioned conventional transflective liquid crystal display device is manufactured through many processes, such as a process for forming a thick reflective film on a substrate and then a process for forming a filter layer so as to cover the reflective film, resulting in an increase in manufacturing cost and the difficulty of manufacture.

### SUMMARY OF THE INVENTION

Accordingly, the present invention has been made to solve the above problems, and it is an object of the present invention to provide a transflective liquid crystal display panel and a transflective liquid crystal display device that can display a high-definition image though using any one of external light and illumination light, and can be easily manufactured at low cost.

In order to attain the above object, the present invention provides a transflective liquid crystal display panel comprising: an insulating layer having a flat upper surface; a resin layer formed on the upper surface of the insulating layer; light-transmitting portions each having a groove which is formed in a portion of the resin layer and through a bottom surface of which the upper surface of the insulating layer is exposed; light transmissive electrodes each covering the bottom surface of the groove; light-reflecting portions in which portions of the resin layer other than portions corresponding to the light-transmitting portions are covered with a reflective film; and a filter layer which is formed over the resin layer with a liquid crystal layer interposed therebetween, and in which portions of the filter layer corresponding to the light-transmitting portions are thicker than other portions.

According to the transflective liquid crystal display panel, even if any one of reflected light and transmitted light is used as light for illuminating the liquid crystal display panel, it is possible to make an optical path length of reflected light equal to an optical path length of transmitted light when they pass through the liquid crystal display panel.

By making the optical path length of reflected light equal to the optical path length of transmitted light, even if any one of reflected light of external light and transmitted light 6f illumination light from the illuminating device is used for illuminating the liquid crystal display panel, it is possible for the liquid crystal display panel to exhibit the same color and brightness. More specifically, even when any one of a frontlight and a backlight is used, it is possible for the liquid crystal display panel to display a high-definition image and have a good visibility constantly.

When the depth of the groove in the light-transmitting portion is ‘D’, the difference in thickness between the liquid crystal layer in the light-transmitting portion and the liquid crystal layer in the light-reflecting portion is ‘L’, and the difference in thickness between the filter layer in the light-transmitting portion and the filter layer in the light-reflecting portion is ‘F’, the respective values are set to satisfy the formula D=L+F. In this way, the optical path length of reflected light becomes equal to the optical path length of transmitted light, and thus the liquid crystal display panel can exhibit the same color and brightness even if any one of reflected light and transmitted light is used.

According to the present invention, preferably, the thickness FR of the filter layer in the light-reflecting portion is set in the range of 0.4 to 2.0 μm, the thickness FT of the filter layer in the light-transmitting portion is set in the range of FR to FR+1.0 μm, the thickness LR of the liquid crystal layer in the light-reflecting portion is set in the range of 1.8 to 3.3 μm, and the thickness LT of the liquid crystal layer in the light-transmitting portion is set in the range of 3.5 to 5.3 μm.

According to the present invention, the liquid crystal display panel may further comprises switching elements covered with the insulating layer and contact holes for electrically connecting the switching elements formed in the insulating layer to the light transmissive electrodes. In addition, the present invention provides a transflective liquid crystal display device comprising the transflective liquid crystal display panel according to any one of the above-mentioned aspects and an illuminating device for illuminating the transflective liquid crystal display panel.

Further, the present invention provides a method for manufacturing a transflective liquid crystal display device comprising an insulating layer having a flat upper surface, a resin layer formed on the upper surface of the insulating layer, light-transmitting portions each having groove which is formed in the insulating layer and through a bottom surface of which the upper surface of the insulating layer is exposed; light transmissive electrodes each covering the bottom surface of the groove; and light-reflecting portions in which potions of the resin layer other than portions corresponding to the light-transmitting portions are covered with a reflective film, the method comprising the steps of: depositing a filter material on a substrate; forming a light transmissive resist layer on portions of the filter material corresponding to the light-transmitting portions; and forming a filter layer having a different thickness in portions corresponding to the light-reflecting portion and the light-transmitting portion, by etching the filter material and the resist layer to thin the portions of the filter layer corresponding to the light-reflecting portions.

### BRIEF DESCRIPTION OF THE DRAWINGS

FIG. 1 is an enlarged cross-sectional view illustrating a portion of a structure of an active matrix type transflective liquid crystal display device;

FIG. 2 is an enlarged plan view illustrating a liquid crystal panel constituting the transflective liquid crystal display device shown in FIG. 1;

FIG. 3A is an enlarged perspective view of a resin layer and a reflective film shown in FIG. 1, and FIG. 3B is an enlarged plan view thereof;

FIG. 4 is a cross-sectional view illustrating the inner structure of a concave portion formed in the reflective film;

FIG. 5 is a graph illustrating an example of a reflection characteristic of the concave portion shown in FIG. 4; and

FIG. 6 is an explanatory view illustrating a manufacturing method of the transflective liquid crystal display device.

### DESCRIPTION OF THE PREFERRED EMBODIMENTS

As an embodiment of a transflective liquid crystal display panel of the present invention, an active matrix type transflective liquid crystal display device will now be described. In the drawings, a rate of a film thickness or other dimensions of each component is differently illustrated from an actual value thereof for promoting understanding.

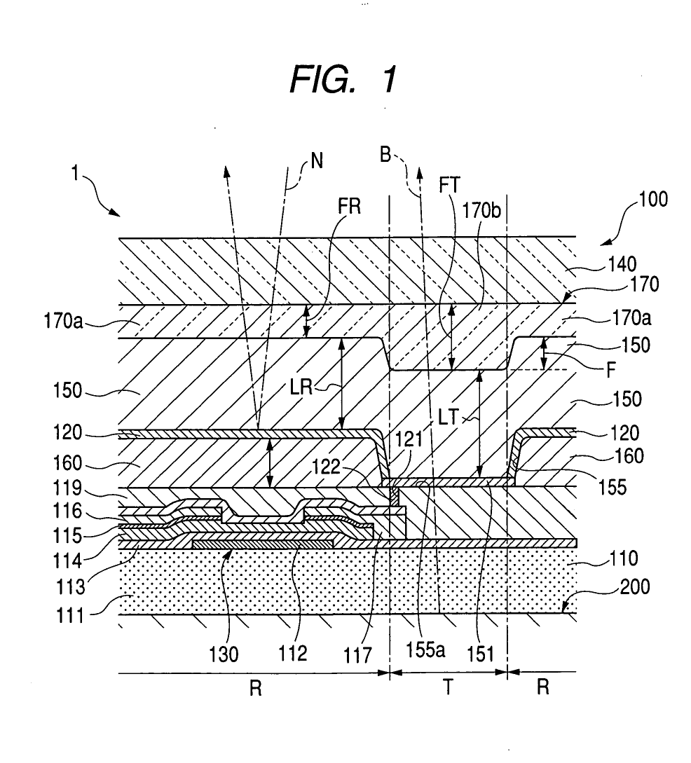

As shown in FIG. 1, a transflective liquid crystal display device of the present embodiment (hereinafter, referred to as a liquid crystal display device) 1 comprises a transflective liquid crystal display panel (hereinafter, referred to as a liquid crystal panel) 100 and a backlight 200, which is an illuminating device arranged below the liquid crystal panel 100. The liquid crystal panel 100 comprises an active matrix substrate (a lower substrate) 110, an upper substrate 140, and a liquid crystal layer 150 formed between these substrates 110 and 140.

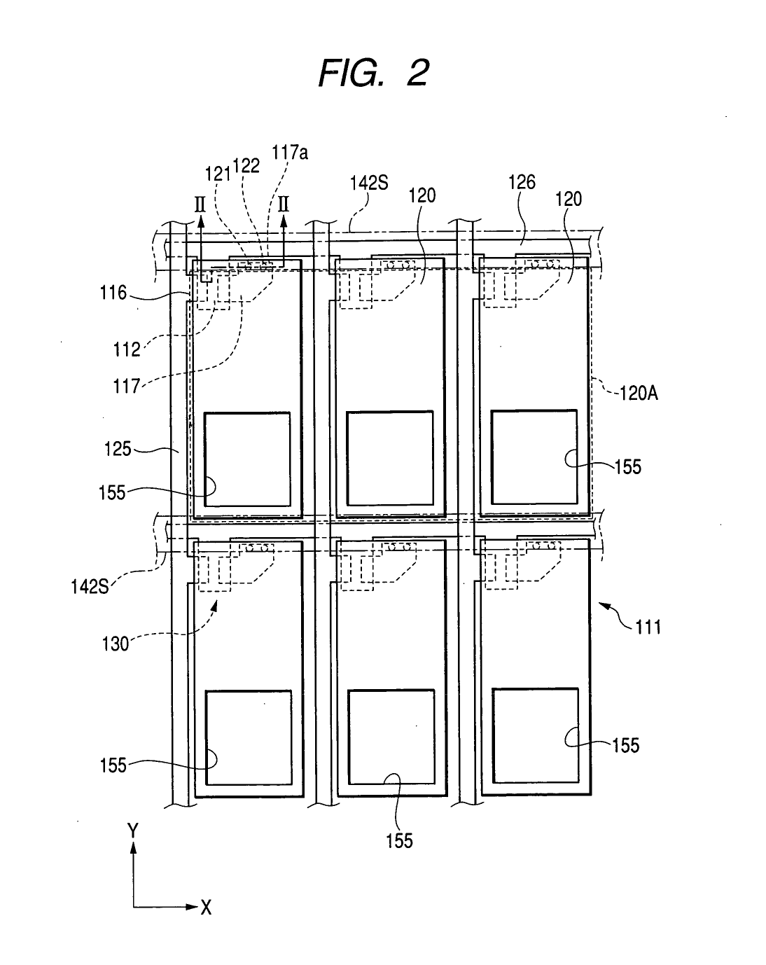

As shown in FIG. 2, in the active matrix substrate 110, a plurality of scanning lines 126 and a plurality of signal lines 125 are respectively formed on a substrate main body 111 made of, for example, glass or plastic in the horizontal direction (in the X direction) and in the vertical direction (in the y direction) such that they are electrically isolated from each other, and TFTs (switching elements) 130 are formed in the vicinities of the intersections of the scanning lines 126 and the signal lines 125. On the substrate 100, a region in which a reflective film 120 constituting a pixel electrode is formed, a region in which the TFT is formed, and a region in which the scanning line 116 and the signal line 115 are formed, and these regions are hereinafter referred to as a pixel region, an element region, and a line region, respectively.

Returning to FIG. 1, the TFT 130 of the present embodiment has a reverse stagger structure in which a gate electrode 112, a gate insulating film 113, semiconductor layers 114 and 115, a source electrode 116, and a drain electrode 117 are sequentially formed on the lowermost layer of the substrate main body 111. That is, the gate electrode 112 is formed by extending a portion of the scanning line 126, and an island-shaped semiconductor layer 114 is formed on the gate insulating layer 113 covering the gate electrode 112 so as to be across the gate electrode 112 in plan view. In addition, the source electrode 116 is formed at one of both ends of the semiconductor layer 114 with the semiconductor layer 115 interposed therebetween, and the drain electrode 117 is formed at the other of both ends of the semiconductor layer 114 with the semiconductor layer 115 interposed therebetween.

As the substrate main body 111, a transmissive insulating substrate made of a natural resin or a synthetic resin, such as polyvinyl chloride, polyester, or polyethyleneterephthalate, other than glass may be used, which transmits light emitted from the backlight 200.

The gate electrode 112 is preferably made of a metallic material, such as aluminum (Al), molybdenum (Mo), tungsten (W), tantalum (Ta), titanium (Ti), copper (Cu), or chromium (Cr), or an alloy of two or more of these metallic materials, such as Mo—W. As shown in FIG. 2, the gate electrode 112 is integrally formed with the scanning line 126 arranged in the horizontal direction.

The gate insulating layer 113 is made of a silicon-based insulating film of, for example, silicon oxide (SiOₓ) or silicon nitride (SiN_{y}), and is formed on an entire surface of the substrate main body 111 so as to cover the scanning lines 126 and the gate electrodes 112 shown in FIG. 2.

The semiconductor layer 114 is an i-type semiconductor layer made of amorphous silicon (a-Si) in which no impurities are doped. A portion of the semiconductor layer 114 which is opposite to the gate electrode 112 with the gate insulating layer 113 interposed therebetween becomes a channel region. The source electrode 116 and the drain electrode 117 are preferably made of a metallic material, such as Al, Mo, W, Ta, Ti, Cu, or Cr, or an alloy of two or more of these metallic materials, and are formed on the i-type semiconductor layer 114 so as to be opposite to each other with the channel region interposed therebetween. Further, the source electrode 116 is formed by extending the signal line 125 arranged in the vertical direction.

Moreover, an n-type semiconductor layer 115 in which a V-group element, such as phosphorous (P), is highly doped is provided between the i-type semiconductor layer 114 and the source and drain electrodes 116 and 117 in order to obtain a good ohmic contact between the i-type semiconductor layer 114 and the source and drain electrodes 116 and 117.

An insulating layer 119 having a flat upper surface is formed on the substrate main body 111 so as to cover the TFTs 130. The insulating layer 119 is preferably made of an inorganic insulating material including a silicon-based insulating film, such as a silicon nitride (SiN) film, or an organic insulating material, such as acryl-based resin, polyimide resin, or benzocyclobutene polymer.

The insulating layer 119 is formed on the TFT 130 as a comparatively thick film to reliably insulate the reflective film 120 from the TFTs 130 and the lines 126 and 125. Therefore, it is prevented that a large parasitic capacitance is generated between the TFTs 130 and the reflective film 120. Further, with the insulating layer 119, the step difference formed by the TFTs 130 and the lines 126 and 125 on the substrate main body 111 is smoothed.

A resin layer 160 is formed on the insulating layer 119. The resin layer 160 is preferably made of, for example, a photosensitive resin (photoresist). The resin layer 160 is preferably formed in a predetermined pattern by means of a photolithography method.

Grooves 155 for transmitting light emitted from the backlight 200 are formed in the resin layer 160. Each of the grooves 155 is formed in a rectangular shape having a size of, for example, 30 μm by 30 μm to 60 μm by 140 μm, and is filled with the liquid crystal layer 150. In addition, a light transmissive electrode 151 is formed to cover the bottom surface 155a of the groove 155. The light transmissive electrode 151 is made of a transparent conductive material, such as ITO, to have a thickness of about 0.05 to 0.3 μm. A light-transmitting portion T for transmitting illumination light emitted from the backlight 200 is formed by the groove 151 and the light transmissive electrode 151.

Contact holes 121 for electrically connecting the drain electrodes 117 to the light transmissive electrodes 151 are formed in the insulating layer 119. The reflective film 120 constituting the pixel electrode is electrically connected to the light transmissive electrode 151 and the drain electrode 117 arranged below the insulating layer 119 via a conductor 122 filled in the contact hole 121. Any number of contact holes 121 may be formed with respect to one pixel.

The reflective film 120 is formed on the resin layer 160 excepting portions in which the grooves 155 are formed. The reflective film 120 is made of a metallic material having high reflectance, such as Al or Ag, to reflect light (external light) coming from the substrate 140. The reflective film 120 is formed at a plurality of places in a matrix type on the resin layer 160 so as to respectively correspond to regions divided by the scanning lines 126 and the signal lines 125. The edges of the reflective film 120 are arranged along the scanning line 126 and the signal line 125, such that almost the entire surface of the substrate main body 111 other than the TFTs 130, the scanning lines 126, and the signal lines 125 becomes the pixel regions.

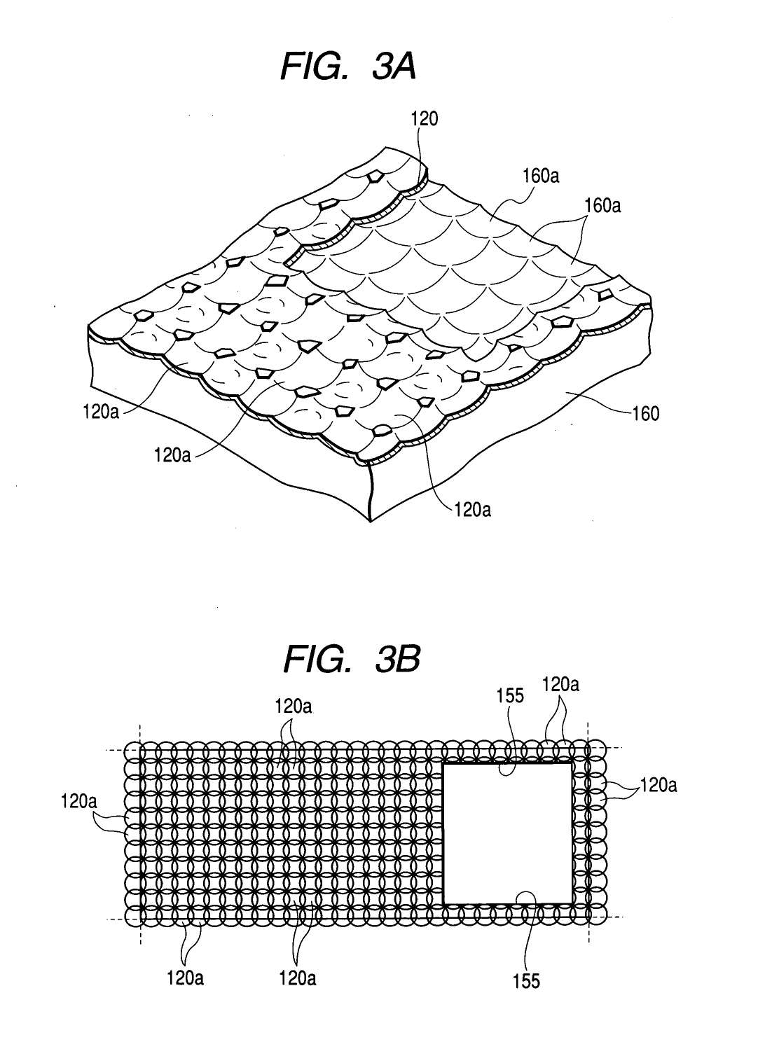

As shown in FIGS. 3A and 3B, a plurality of minute concave portions 160a are formed on the surface of the resin layer 160 corresponding to the pixel regions by pressing the surface of the resin layer 160 with a transcribing mold having an uneven surface. The reflective film 120 is formed in a predetermined surface shape (concave portions 120a) depending on the shapes of the concave portions 160a formed on the resin layer 160. Some of light incident on the liquid crystal panel 100 are scattered by the concave portions 120a formed on the reflective film 120, thereby obtaining brighter display at a wider viewing angle.

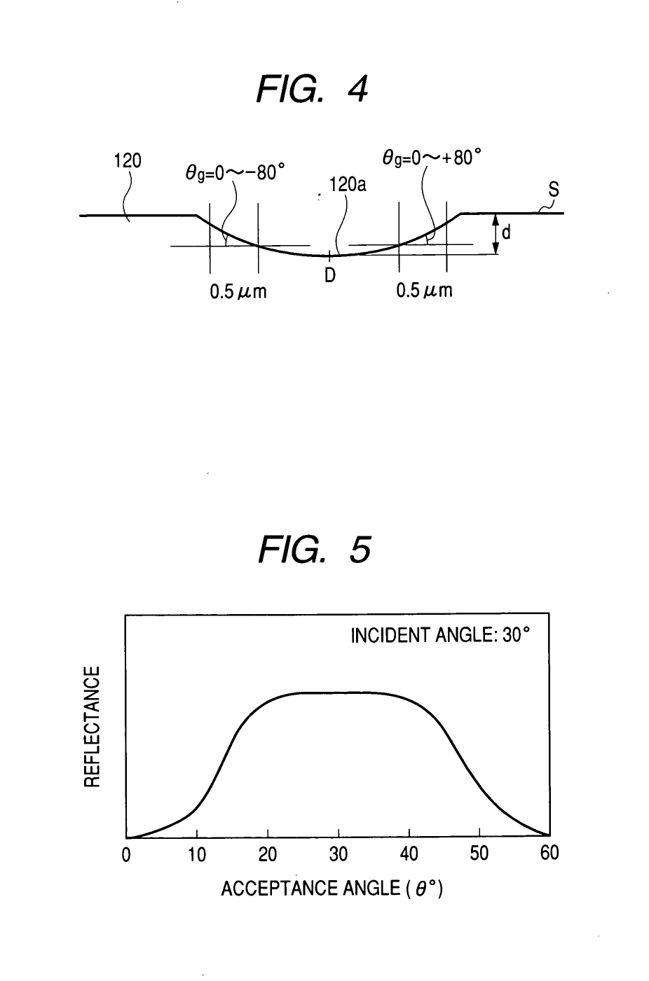

As shown in FIG. 4, the inner surface of the concave portion 120a is formed of a spherical surface. Therefore, when light is incident on the reflective film 120 at a predetermined angle (for example, 30°) and is then reflected and diffused therefrom, the brightness distribution of the reflected and diffused light is substantially symmetric with respect to the specular reflection angel. More specifically, an inclined angle θg of the inner surface of the concave portion 120a is set to in the range of −18° to +18°. In addition, the concave portions 120a are arranged such that the pitch between adjacent concave portions 120a is set at random. Therefore, it is possible to prevent the generation of moire due to the arrangement of the concave portions 120a.

Furthermore, for the purpose of the ease of assembly, the concave portion 120a has a diameter of 5 μm to 100 μm and a depth of 0.1 μm to 3 μm. The reason is that, when the depth of the concave portion 120a is less than 0.1 μm, the diffusion effect of reflected light is insufficient, and when the depth of the concave portion 120a is more than 3 μm, the pitch between the concave portions 120a must be widened in order to satisfy the conditions for the inclined angle of the inner surface, which may cause moire.

FIG. 5 illustrates a reflection characteristic of the reflective film 120 having the above structure. In other words, FIG. 5 shows the relationship between a light-receiving angle θ and luminosity (reflectance) when external light is incident on the surface S of the substrate at an incident angle of 30° and a viewing angle shifts from 0° (vertical line direction) to 60° with respect to the normal direction of the surface S of the substrate, from a specular reflection angle of 30° to the surface S of the substrate. On the reflective film 120 of the present embodiment, reflected light is nearly uniform within the angle range of ±10° from the specular reflection angle of 30°. Thus, it is possible to obtain uniform, bright display within the above range.

Returning to FIG. 1, a region in which the groove 155 is formed in the resin layer 160 becomes the light-transmitting portion T, as indicated by arrow T in FIG. 1, which transmits illumination light B emitted from the backlight 200. On the other hand, a region in which the groove 155 is not formed in the resin layer 160 and which is covered with the reflective film 120 becomes a light-reflecting portion R, as indicated by arrow R in FIG. 1, which reflects external light N coming from the substrate 140 toward the substrate 140.

A filter layer 170 is formed underneath the substrate 140. The filter layer 170 is preferably composed of color filters for allowing each pixel in the liquid crystal panel 100 to display three primary colors R, G, and B. The filter layer 170 is preferably twice thicker in the portion corresponding to the light-transmitting portion T than in the portion corresponding to the light-reflecting portion R. The filter layer 170 comprises a thin portion 170a corresponding to the light-reflecting portion R and a thick portion 170b corresponding to the light-transmitting portion T.

Since the thick portion 170b of the filter layer 170 in the light-transmitting portion T is twice thicker than the thin portion 170a in the light-reflecting portion R, external light (reflected light) N reciprocatively passes through the filter layer 170, that is, the thin portion 170a just one time, and the illumination light (transmitted light) B passes through the filter layer 170, that is, the thick portion 170b only once. Therefore, the optical path lengths of external light N and the illumination light B can be equal to each other when they pass through the filter layer 170. Accordingly, it is possible to obtain the same degree of color and brightness even if any one of external light and illumination light emitted from the backlight is used as light for illuminating the liquid crystal panel 100.

The optimum thicknesses of the respective layers constituting the liquid crystal display device 1 constructed as above will be described. First, we define that the thickness of the filter layer 170 in the light-reflecting portion R (the thickness of the thin portion 170a) is ‘FR’, the thickness of the filter layer 170 in the light-transmitting portion T (the thickness of the thick portion 170b) is ‘FT’, the thickness of the light-reflecting portion R in the liquid crystal layer 150 is ‘LR’, the thickness of the liquid crystal layer 150 in the light-transmitting portion T is ‘LT’, and the depth of the groove 115 is ‘D’.

In the liquid crystal display device 1 of the present embodiment, the depth D of the groove 115 formed in the resin layer 160 is formed to satisfy the following formula:
D=(LT−LR)+(FT−FR)

Here, with defining LT−LR as ‘L’ and FT−FR as ‘F’, the above formula becomes D=L+F. If the depth D of the groove satisfies the formula, it is possible to make the optical path length of external light N equal to the optical path length of the illumination light B from the backlight 200 when they pass through the liquid crystal panel 100.

In this way, by making the optical path length of external light N equal to the optical path length of the illumination light B, even if any one of external light N under situations such as out of doors and illumination light B from the backlight 200 is used, it is possible to obtain the same color and brightness from the liquid crystal panel 100. More specifically, even when any one of a frontlight and a backlight is used as a light source, it is possible to display a high-definition image and have a good visibility constantly.

For the thicknesses of each of the above layers, preferably, the thickness FR of the thin portion 170a in the filter layer 170 is set in the range of 0.4 to 2.0 μm, and the thickness FT of the thick portion 170b in the filter layer 170 is set in the range of FR to FR+1.0 μm. In addition, the thickness LR of liquid crystal layer 150 in the light-reflecting portion R is set in the range of 1.8 to 3.3 μm, and the thickness LT of the liquid crystal layer 150 in the light-transmitting portion T is set in the range of 3.5 to 5.3 μm. With the above thickness ranges, even when any one of a frontlight and a backlight is used as a light source, it is possible to display a high-definition image and have a good visibility constantly.

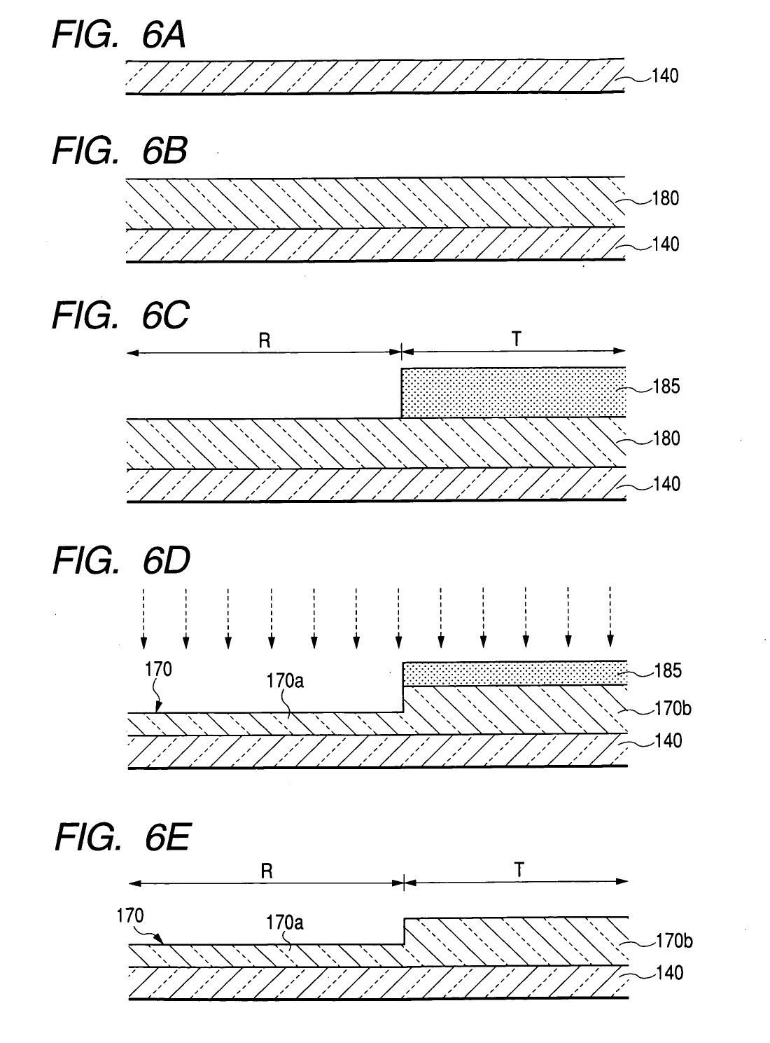

A manufacturing method of the transflective liquid crystal display panel according to the present invention will be described with reference to FIGS. 1 and 6. In the manufacturing method, first, the upper substrate (the substrate) 140 is prepared, which is composed of, for example, a glass substrate and constitutes the transflective liquid crystal display panel (the liquid crystal panel) 100 shown in FIG. 1 (see FIG. 6A). Next, as shown in FIG. 6B, a filter material 180 is deposited on the upper substrate 140. The filter material 180 will be processed into the filter layer 170 by subsequent processes. Further, a colored resin constituting the filter layer 170 may be deposited with a thickness of about 2.0 μm.

Subsequently, as shown in FIG. 6C, a resist layer 185 is deposited on only the region of the filter layer 170 corresponding to the light-transmitting portion T. The resist layer 185 may be formed by depositing a transparent transmissive material, which is the same resin material as the filter material 180 and does not contain pigment, with a thickness of about 2.0 μm.

As shown in FIG. 6D, the resist layer 185 and the exposed portion of the filter material 180 in the light-reflecting portion R are etched by an ion milling method. The etching process is performed until the thickness of the filter material 180 in the light-reflecting portion R reaches 1.0 μm.

In this way, the filter layer 170 comprising the thin portion 170a corresponding to the light-reflecting portion R and the thick portion 170b corresponding the light-transmitting portion T is formed. Subsequently, the layers shown in FIG. 1 such as the active matrix substrate (the lower substrate) 110 are sequentially formed on the filter layer 170 with the liquid crystal layer 150 interposed therebetween. Even if the resist layer 185 remains on the resultant filter layer 170 in the light-transmitting portion T, light can easily pass through the light-transmitting portion T since the resist layer 185 is made of a transparent transmissive material, which is the same resin material as the filter material 180 and does not contain pigment.

As shown in FIG. 6E, the resist layer 185 remaining in the light-transmitting portion T may be removed after the etching process. The remaining resist layer 185 may be removed by a solvent having a selective solubility.

In the above-mentioned embodiment, an active matrix transflective liquid crystal display device is adopted as an example of the transflective liquid crystal display device. However, the present invention is not limited thereto, and can also be similarly applied to a passive liquid crystal display device.

As described above in detail, according to the transflective liquid crystal display panel of the present invention, even if any one of reflected light and transmitted light is used as light for illuminating the liquid crystal display panel, it is possible to make the optical path length of reflected light equal to the optical path length of transmitted light when they pass through the liquid crystal display panel.

By making the optical path length of reflected light equal to the optical path length of transmitted light, even if any one of reflected light of external light and transmitted light of illumination light emitted from an illumination device is used for illuminating the liquid crystal panel, the liquid crystal panel can have the same color and brightness. More specifically, even when any one of the frontlight and the backlight is used, it is possible to display a high-definition image and have a good visibility constantly.

Furthermore, according to the present invention, when the depth of the groove in the light-transmitting portion is ‘D’, the difference in thickness between the liquid crystal layer in the light-transmitting portion and the liquid crystal layer in the light-reflecting portion is ‘L’, and the difference in thickness between the filter layer in the light-transmitting portion and the filter layer in the light-reflecting portion is ‘F’, the respective values are determined to satisfy the expression D=L+F. As a result, the optical path length of reflected light becomes equal to the optical path length of transmitted light, and thus even if reflected light and transmitted light is selectively used, the liquid crystal display panel can exhibit the same color and brightness.

Moreover, preferably, the thickness FR of the filter layer in the light-reflecting portion is set in the range of 0.4 to 2.0 μm, the thickness FT of the filter layer in the light-transmitting portion is set in the range of FR to FR+1.0 μm, the thickness LR of the liquid crystal layer in the light-reflecting portion is set in the range of 1.8 to 3.3 μm, and the thickness LT of the liquid crystal layer in the light-transmitting portion is set in the range of 3.5 to 5.3 μm.

Further, the liquid crystal display panel according to the present invention may further comprise switching elements covered with the insulating layer and contact holes for electrically connecting the switching elements formed in the insulating layer to the light transmissive electrodes. In addition, the present invention provides a transflective liquid crystal display device comprising the liquid crystal display panel according to any one of the above-mentioned aspects and an illuminating device for illuminating the liquid crystal display panel.

1. A transflective liquid crystal display panel comprising:
an insulating layer having a flat upper surface;
a resin layer formed on an upper surface of the insulating layer;
light-transmitting portions each having groove which is formed in the resin layer and through a bottom surface of which the upper surface of the insulating layer is exposed;
light transmissive electrodes each covering the bottom surface of the groove;
light-reflecting portions in which portions of the resin layer other than portions corresponding to the light-transmitting portions are covered with a reflective film; and
a filter layer which is formed above the resin layer with a liquid crystal layer interposed therebetween, and in which the portions of the filter layer corresponding to the light-transmitting portions are thicker than other portions.

2. The transflective liquid crystal display panel according to claim 1, wherein when athe depth of the groove in the light-transmitting portion is ‘D’, a difference in thickness between the liquid crystal layer in the light-transmitting portion and the liquid crystal layer in the light-reflecting portion is ‘L’, and a difference in thickness between the filter layer in the light-transmitting portion and the filter layer in the light-reflecting portion is ‘F’, the respective values are determined to satisfy the formula D=L+F.

3. The transflective liquid crystal display panel according to claim 2, wherein the thickness FR of the filter layer in the light-reflecting portion is set in the range of 0.4 to 2.0 μm, the thickness FT of the filter layer in the light-transmitting portion is set in the range of FR to FR+1.0 μm, the thickness LR of the liquid crystal layer in the light-reflecting portion is set in the range of 1.8 to 3.3 μm, and the thickness LT of the liquid crystal layer in the light-transmitting portion is set in the range of 3.5 to 5.3 μm.

4. The transflective liquid crystal display panel according to claim 1, further comprising:
switching elements covered with the insulating layer, and
contact holes for electrically connecting the switching elements formed in the insulating layer to the light transmissive electrodes.

5. A transflective liquid crystal display device comprising the transflective liquid crystal display panel as claimed in claim 1 and an illuminating device for illuminating the transflective liquid crystal display panel.

6. A method of manufacturing a transflective liquid crystal display device comprising an insulating layer having a flat upper surface, a resin layer formed on an upper surface of the insulating layer, light-transmitting portions each having groove which is formed in the insulating layer and through a bottom surface of which the upper surface of the insulating layer is exposed, light transmissive electrodes each covering the bottom surface of the groove, and light-reflecting portions in which portions of the resin layer other than portions corresponding to the light-transmitting portions are covered with a reflective film, the method comprising the steps of:
depositing a filter material on a substrate;
forming a light transmissive resist layer on portions of the filter material corresponding to the light-transmitting portions; and
forming a filter layer having a different thickness in portions corresponding to the light-reflecting portion and the light-transmitting portion, by etching the filter material and the resist layer to thin the portions of the filter layer corresponding to the light-reflecting portions.
